(19) United States
(12) Patent Application Publication
(10) Pub. No.: US 2022/0236072 A1
(43) Pub. Date: Jul. 28, 2022

(54) INDOOR POSITIONING AND TRACKING USING SPATIAL FEATURES

(71) Applicant: POS8 Limited, Harrow (GB)

(72) Inventors: Benjamin T. Jones, Las Vegas, NV (US); Jason M. Jeffereys, Harrow (GB)

(73) Assignee: POS8 Limited, Harrow (GB)

(21) Appl. No.: 17/579,158

(22) Filed: Jan. 19, 2022

Related U.S. Application Data
(60) Provisional application No. 63/140,565, filed on Jan. 22, 2021.

(51) Int. Cl. G01C 21/00; G01C 21/20; H04W 4/33; H04B 17/318

(52) U.S. Cl. CPC G01C 21/383; G01C 21/206; H04B 17/318; H04W 4/33; G01C 21/3885

(57) ABSTRACT

A system and method for indoor positioning and tracking that uses beacon signal data, sensor data, and/or wireless network fingerprinting to create a moving map of radiofrequency (RF) devices in an indoor location. The moving map is continuously repaired and updated. The system incorporates user data into the moving map to enhance customer service and customer experience.

### CROSS REFERENCE TO OTHER APPLICATIONS

This application is related to and claims priority from the following U.S. patents and patent applications. This application claims priority to and the benefit of U.S. Provisional Application No. 63/140,565, filed Jan. 22, 2021, which is incorporated herein by reference in its entirety.

### BACKGROUND OF THE INVENTION

### 1. Field of the Invention

The present invention relates to indoor positioning, and more specifically to systems and methods for creating a moving map that is operable to locate and track radiofrequency (RF) devices in an indoor setting. The moving map further incorporates information to enhance customer service and customer experience.

### 2. Description of the Prior Art

There are many methods of indoor positioning. It is generally known in the prior art to provide systems for indoor positioning using radiofrequency beacons and/or sensor data from a mobile device. These systems are generally combined with floor plans or known maps to determine indoor location. It is also generally known in the prior art to track the indoor location of radiofrequency devices such as mobile phones.

Prior art patent documents include the following:

U.S. Patent Publication No. 2020/0154243 for Electronic identification, location tracking, communication & notification system with beacon clustering by inventor Kusens, filed Jan. 10, 2020 and published May 14, 2020, discloses a system and method for identifying a customer's location at a business and provide notification to a company representative upon arrival of the customer at the business location. Real-time location determinations for the customer and customer location tracking can be provided. One or more wireless beacons communicate with the customer's electronic device. The beacons provide the system with real-time data about the customer's whereabouts, allowing for the confirmation and tracking of the customer at the location. A first non-limiting example of use, include a company that provides food and beverage allowing the customer to place an order for food and beverages on their electronic device and having the order delivered to the person at their current location as determined by the system. Another non-limiting example includes a company using the notification system to have assigned staff members notified of the customer's arrival.

U.S. Pat. No. 10,244,362 for Use of RF-based fingerprinting for indoor positioning by mobile technology platforms by inventors Titus et al., filed Sep. 29, 2017 and issued Mar. 26, 2019, discloses a method for determining the position of a mobile technology platform within a structure, wherein the mobile technology platform is equipped with a gyroscope, a magnetometer and at least one accelerometer. The method includes deploying a set of RF (radio frequency) beacons within the structure, wherein each RF beacon emits an RF signal; recording, at each of a set of sampling locations within the structure, the RF signature created by the RF signals received at the location, wherein said recording is performed by a digital image correlation (DIC) platform which traverses the structure, and which correlates the recorded RF signatures to a floor map of the structure; forming an RF fingerprint of the structure from the recorded RF signatures; and using the RF fingerprint, in conjunction with readings from the gyroscope, magnetometer and at least one accelerometer to determine the location of the device within the structure.

U.S. Patent Publication No. 2020/0217666 for Aligning measured signal data with slam localization data and uses thereof by inventors Zhang et al., filed Jan. 17, 2020 and published Jul. 9, 2020, discloses a method including retrieving a map of a 3D geometry of an environment, the map including a plurality of non-spatial attribute values each corresponding to one of a plurality of non-spatial attributes and indicative of a plurality of non-spatial sensor readings acquired throughout the environment, receiving a plurality of sensor readings from a device within the environment wherein each of the sensor readings corresponds to at least one of the non-spatial attributes and matching the plurality of received sensor readings to at least one location in the map to produce a determined sensor location.

U.S. Patent Publication No. 2020/0018812 for A method for generating an indoor environment model and a method for determining position data for a location in an indoor environment by inventors Lindquist et al., filed Jan. 11, 2018 and published Jan. 16, 2020, discloses a method for generating an indoor environment model of a building comprising forming a transmitter location model for defining positions of transmitters in said building using gathered information for establishing transmitter locations, receiving signal strength indicative measurements being determined for a number of transmitters using at least one electronic communications device, wherein the signal strength indicative measurements are based on a signal which has varying signal propagation characteristics in the indoor environment, and wherein said signal strength indicative measurements are acquired from a number of known locations in the building, identifying discrepancies of signal transmittance in said indoor environment based on said signal strength indicative measurements in relation to said transmitter location model, determining locations of signal hindering elements causing said discrepancies, and generating said indoor environment model including transmitter locations and said signal hindering elements.

U.S. Pat. No. 8,792,906 for Providing derived location information for customer relationship in response to receipt of short range wireless beacon by inventors Batada et al., filed Apr. 24, 2012 and issued Jul. 29, 2014, discloses a mobile station configured to detect entry into a premises of an enterprise in response to short range or near field radio-frequency signals. The mobile station receives signals from one or more short range wireless beacons located in the premises, and the mobile station sends identifiers from the beacon signals to a location server. The location server processes the identifiers to determine location of the mobile station within the premises and sends information to the mobile station, for presentation to the user of a map of the premises showing the determined location of the mobile station within the premises. Entry detection also may be used to automatically check-in a customer/user of the mobile station with a system of the enterprise used by personnel of the enterprise at the premises to enable the personnel to customize interactions the customer while the customer is at the premises.

U.S. Pat. No. 9,918,204 for High accuracy indoor tracking by inventors Cote et al., filed Dec. 8, 2015 and issued Mar. 13, 2018, discloses a technique for tracking a mobile device within a building. A course position estimate of the mobile device is determined using a positioning system. The course position estimate indicates a room in which the mobile device is located. One or more sensors of the mobile device capture a live point cloud of surroundings of the mobile device. Tracking software accesses a portion of a pre-captured point cloud of the interior of the building that serves as a reference. The portion of the pre-captured point cloud corresponds to the room indicated by the course position estimate. Once the initial pose is determined, an updated pose of the mobile device is determined when the mobile device is moved, based on a further comparison of the live point cloud to the portion of the pre-captured point cloud.

U.S. Pat. No. 10,440,678 for Estimating locations of mobile devices in a wireless tracking system by inventors Hedley et al., filed Mar. 10, 2017 and issued Oct. 8, 2019, discloses a wireless tracking system comprising mobile devices and stationary devices at known locations. The system receives a first radio measurement indicative of a first propagation path length and receives sensor data indicative of the movement of the first mobile device. The sensor data is of a type different to the radio measurement. The system then determines a historical location of the first mobile device based on the first radio measurement and the sensor data and determines error data indicative of a difference between a historical radio measurement and the historical location and stores the error data associated with the historical location. The system can then receive a second radio measurement indicative of a second propagation path length of radio frequency radiation and determine an estimated location of the second mobile device based on the second radio measurement and the stored error data.

U.S. Pat. No. 10,733,681 for Precise anticipatory hotel room entry system by inventors Boss et al., filed Feb. 8, 2017 and issued Aug. 4, 2020, discloses a method, system, and computer program product for managing hotel operations. The method comprises using a hotel computer system to track the locations of a guest in a hotel over time through a mobile device for the guest. The hotel computer system identifies a pattern of movement in the hotel using the locations tracked over time. The hotel computer system preforms an action in the hotel enabling managing the hotel operations for the hotel.

U.S. Pat. No. 7,038,584 for Object location monitoring within buildings by inventor Carter, filed Feb. 21, 2003 and issued May 2, 2006, discloses an object location tracking system for tracking a movable object including a plurality of beacons spatially distributed within a building, each beacon transmitting a respective ID signal, at least one transceiver device which receives the transmission of ID signals from the beacons and determines received signal strengths of such transmissions, the transceiver device adapted to be attached to the movable object, a motion detector coupled to the at least one transceiver device configured to provide information relating to a motion of the at least one transceiver device, and a processing module that uses information reflective of the received signal strengths of the transmissions received by the transceiver device, in combination with information reflective of the motion of the at least one transceiver device, to determine a current location of the transceiver device.

### SUMMARY OF THE INVENTION

The present invention relates to indoor positioning and tracking.

It is an object of this invention to provide systems and methods for mapping and tracking radiofrequency devices in an indoor location, wherein the system uses beacon signal data, sensor data, and/or wireless network (such as WIFI) fingerprinting to determine the location of the radiofrequency devices. It is further an object of this invention to provide systems and methods for delivering goods and/or services based on a moving map of the radiofrequency devices.

In one embodiment, the present invention is directed to a system for positioning and tracking at least one user device, including a server in network communication with at least one signaling device, wherein the server is operable to receive scan data from at least one user device in network communication with the server, wherein the scan data includes a point cloud map of a location, wherein the at least one signaling device is operable to receive signals from the at least one user device and transmit messages to the server including signal data regarding the at least one user device, and wherein the server is operable to determine a location of the at least one user device based on the scan data and the signal data.

In another embodiment, the present invention is directed to a system for positioning and tracking at least one user, including a server in network communication with at least one signaling device, at least one user device in network communication with the server and/or the at least one signaling device, wherein the server is operable to receive scan data from the at least one user device, wherein the scan data corresponding to at least one unique identifier, wherein the at least one signaling device is operable to receive signals from the at least one user device and transmit messages to the server including signal data regarding the at least one user device, and wherein the server is operable to determine a location of the at least one user device based on the scan data and the signal data.

In yet another embodiment, the present invention is directed to a method for positioning and tracking at least one user, including a server receiving scan data from at least one user device, wherein the scan data includes a point cloud map of a location in the vicinity of the at least one user device, at least one signaling device receiving signals from the at least one user device and transmitting messages to the server including signal data regarding the at least one user device, the server determining a location of the at least one user device based on the scan data and the signal data, and the server generating a map including the location of the at least one user device, and transmitting the map to at least one management device.

These and other aspects of the present invention will become apparent to those skilled in the art after a reading of the following description of the preferred embodiment when considered with the drawings, as they support the claimed invention.

### BRIEF DESCRIPTION OF THE DRAWINGS

FIG. 1 illustrates one embodiment of a tag attached to a beacon.

FIG. 2 illustrates one embodiment of a visualization of a moving map.

FIG. 3 illustrates one embodiment of the process for delivering an order.

FIG. 4 is a schematic diagram of a system of the present invention.

### DETAILED DESCRIPTION

The present invention is generally directed to systems and methods for indoor positioning and tracking.

In one embodiment, the present invention is directed to a system for positioning and tracking at least one user device, including a server in network communication with at least one signaling device, wherein the server is operable to receive scan data from at least one user device in network communication with the server, wherein the scan data includes a point cloud map of a location, wherein the at least one signaling device is operable to receive signals from the at least one user device and transmit messages to the server including signal data regarding the at least one user device, and wherein the server is operable to determine a location of the at least one user device based on the scan data and the signal data.

In another embodiment, the present invention is directed to a system for positioning and tracking at least one user, including a server in network communication with at least one signaling device, at least one user device in network communication with the server and/or the at least one signaling device, wherein the server is operable to receive scan data from the at least one user device, wherein the scan data corresponding to at least one unique identifier, wherein the at least one signaling device is receive signals from the at least one user device and transmit messages to the server including signal data regarding the at least one user device, and wherein the server is operable to determine a location of the at least one user device based on the scan data and the signal data.

In yet another embodiment, the present invention is directed to a method for positioning and tracking at least one user, including a server receiving scan data from at least one user device, wherein the scan data includes a point cloud map of a location in the vicinity of the at least one user device, at least one signaling device receiving signals from the at least one user device and transmitting messages to the server including signal data regarding the at least one user device, the server determining a location of the at least one user device based on the scan data and the signal data, and the server generating a map including the location of the at least one user device, and transmitting the map to at least one management device.

None of the prior art discloses indoor positioning and tracking to create a moving map of radiofrequency devices that further integrates additional information about the radiofrequency devices onto the moving map. The prior art also does not disclose beacons that are operable to learn and share location data with other radiofrequency devices. Though the prior art may disclose indoor positioning and tracking, there is currently no system that creates a continuously updating and continuously self-repairing moving map of radiofrequency devices.

Indoor positioning and tracking requires different technologies in addition to or in place of the standard Global Positioning System (GPS) used for outdoor location services. GPS relies on satellite coverage, which is less accurate in indoor settings due to signal reflection, scattering, and attenuation in and around buildings and other structures. In addition, indoor tracking of radiofrequency devices in a smaller enclosed space often requires greater accuracy than outdoor positioning. It is helpful in a retail or service setting to have continuously updated location data for customers, staff, and other people in an area. It is also helpful to use location data in an integrated system to improve customer service.

The present invention is directed to systems and methods for creating a moving map of radiofrequency devices in an indoor location. The moving map is created using beacon signal data, sensor data, and/or wireless network (such as WIFI) fingerprinting. The moving map further integrates data about the indoor location, the radiofrequency devices, and/or users associated with the radiofrequency devices to enable customer service. The moving map is useful in restaurant and service industries in order to accurately deliver goods and services to customers. For example, the system of the present invention is operable to electronically collect customer orders from customers at a restaurant. The system creates the moving map of customer locations using beacon signal data, sensor data, and/or wireless network fingerprinting. The system is then operable to integrate the moving map with the customer orders into a visualization (e.g., an augmented reality (AR) visualization). The visualization directs a waiter to bring a correct order to a current location of a customer. In one embodiment, the current location is at a table. Alternatively, the current location is at a bar. The system eliminates inefficiencies and/or errors that occur when waiters need to manually record and remember orders, table numbers, and other customer information, especially during busy times. The system also enables waiters to notify the customers when a take-out order is ready and bring the take-out order directly to the customer, making pick-up quicker and reducing crowding. Advantageously, the systems and methods of the present invention do not require a known floorplan or known map of the indoor location in order to create the moving map.

Referring now to the drawings in general, the illustrations are for the purpose of describing one or more preferred embodiments of the invention and are not intended to limit the invention thereto.

In one embodiment, the present invention includes at least one user device in network communication with a server. The at least one user device of the present invention includes but is not limited to a mobile phone, a smart phone, a wearable device, an AR device, a tablet, and/or a computer. In one embodiment, the present invention includes an application, wherein the application is installed on the user device. In another embodiment, the application is accessed by the at least one user device via a web browser. The present invention further includes at least one radiofrequency device. The at least one radiofrequency device includes but is not limited to beacons, radiofrequency tags, mobile devices, wearable devices, tablets, computers, pay stations, and/or routers. In one embodiment, the at least one radiofrequency device is attached to a ceiling, wall, floor, article of furniture, standing fixture, and/or overhead fixture. In another embodiment, the at least one radiofrequency device is a portable device carried by a user. In one embodiment, the system of the present invention includes a data collection engine, a location engine, and a mapping engine. The mapping engine is operable to combine data from the data collection engine and data from the location engine. The data collection engine, the location engine, and the mapping engine are operable for network communication with the at least one user device, the at least one radiofrequency device, and the server. The server is operable to store and analyze data from the data collection engine, the location engine, and the mapping engine. In one embodiment, the present invention includes an edge device. In one embodiment, the at least one radiofrequency device is an edge device.

In one embodiment, the present invention uses signal data from at least one beacon, sensor data, and/or wireless network (such as WIFI) fingerprinting to locate and track radiofrequency devices. In a preferred embodiment, the present invention uses a combination of signal data from at least one beacon and at least one sensor to locate and track the radiofrequency devices. In another embodiment, the present invention includes at least one camera and/or light detection and ranging (LiDAR) detector, which is used to track both individuals and objects within the area. The camera and/or LiDAR detector are operable to be mounted (e.g., overhead).

The location engine of the present invention is operable to determine the location of the user device after the user device scans the tag. In one embodiment, the location of the user device is determined using signal data from at least one beacon, sensor data, and/or wireless network fingerprinting. In a preferred embodiment, the location of the user device is determined using a combination of signal data from at least one beacon, sensor data, and/or wireless network fingerprinting.

In a preferred embodiment, the present invention includes a plurality of beacons. Each of the plurality of beacons emits at least one beacon signal. The at least one beacon signal includes but is not limited to an RF signal, a BLUETOOTH Low Energy (LE) signal, a WI-FI signal, a light signal, a quantum communication signal, and/or an ultrasound signal. In one embodiment, the at least one beacon emits a combination of beacon signals. The at least one beacon is also operable to receive and record beacon signals and/or signals from the user device. In one embodiment, the system is operable to create a probability distribution of the beacon signals in an area designated by the host. The location engine is operable to collect and analyze data on the beacon signals received by the user device and determine the location of the user device based on the beacon signals received by the user device and the probability distribution of the beacon signals. In one embodiment, the location engine uses received signal strength indication (RSSI) ranging and/or trilateration of the beacon signals to determine the location of the user device.

In one embodiment, the probability distribution is determined using at least one of a Bayesian filter, a Kalman filter, a particle filter, a Bayesian network, a hidden Markov model, and/or a Monte Carlo method.

In one embodiment, the location engine of the present invention is operable to collect and analyze sensor data from the user device in order to determine the location of the user device. The sensor data includes but is not limited to accelerometer data, magnetometer data, gyroscope data, barometer data, ambient light data, proximity sensor data, temperature data, humidity data, an image, a video, an audio recording WI-FI signal data, radiofrequency signal data, GPS data, depth sensor data, visual odometry data, LiDAR data, and/or “virtual sensor” data taken from the combination of two or more of the above-mentioned types of sensor data. In a preferred embodiment, the location engine is operable to perform sensor fusion and collects and analyzes a combination of sensor data from a plurality of sensors in order to determine the location of the user device. In one embodiment, the location engine is operable to create a point cloud of the area surrounding the user device based on the depth sensor data and/or the LiDAR data. The location engine is further operable to create a three-dimensional mesh of the area based on the depth sensor data and/or the LiDAR data. The point cloud includes a plurality of spatial hints and/or anchors. In one embodiment, the system uses computer vision to analyze image and/or video data. The system is operable to detect objects and/or people in image and/or video data. In one embodiment, the system further uses an artificial intelligence module for scene understanding which is operable to recognize types of furniture or elements of a location (e.g., doors, windows, walls, floors, etc.) based on the plurality of spatial hints, anchors, and/or other point cloud data. In another embodiment, the point cloud is supplemented by other sensor data in order to assist in recognizing types of furniture or elements of a location. Thus, the system is operable to create vectors between different forms of sensor and radiofrequency data. In one embodiment, the system is operable to create a model of user device motion based on the combination of sensor data. The model is preferably combined with other methods of indoor positioning to track the user device as it moves.

In one embodiment, the location engine is operable to determine the location of the user device via wireless network fingerprinting. In one embodiment, the wireless network fingerprinting includes WI-FI fingerprinting. The system is operable to create a probability distribution of wireless signals throughout the area from routers with known locations. The location engine is operable to use channel state information (CSI) and/or received signal strength indicators (RSSIs) to determine the location of the user device based on the wireless signals received by the device and the probability distribution of wireless signals throughout the area.

The mapping engine of the present invention is operable to create a moving map of the radiofrequency devices including the user devices in an area based on data from the location engine and data from the data collection engine. In a preferred embodiment, at least part of the moving map is created using a spatial survey. The spatial survey is conducted by an augmenting device. The augmenting device is a radiofrequency device that traverses the area and collects spatial survey data. The augmenting device also continuously observes the RF environment and updates the moving map. The spatial survey data includes but is not limited to beacon signal data, sensor data, and wireless signal data. The sensor data includes LiDAR and camera data. In one embodiment, the mapping engine includes computer vision algorithms for building the moving map. In one embodiment, the mapping engine is operable to build the moving map using the spatial survey at a rate of about 100 square feet per minute. In one embodiment, the mapping engine is operable to accurately map the radiofrequency devices in the moving map with an accuracy of about 10 centimeters. In a preferred embodiment, the area is an indoor area (e.g., a restaurant). In another embodiment, the area is partially indoors (e.g., a lean-to structure and/or a partially covered structure). Advantageously, the spatial survey means that the system does not require a floor plan of the area in order to create and/or calibrate the moving map.

In one embodiment, the mapping engine is operable to detect when the moving map is inaccurate and take steps to correct the moving map. For example, in an embodiment wherein the radiofrequency devices are movable devices, the system is operable to determine if the radiofrequency devices are no longer at the locations last recorded by the moving map. When the radiofrequency devices are sufficiently out of place, the system sends an alert to a location manager informing them that a new spatial survey is required to repair the moving map. In one embodiment, the system is able to automatically perform a new spatial survey whenever the radiofrequency devices move by a predetermined amount. In another embodiment, the system is operable to detect when a radiofrequency device is defective. Data from a defective radiofrequency device is disregarded and data from other radiofrequency devices surrounding the defective radiofrequency device is used to repair the moving map.

The mapping engine is operable to track the radiofrequency devices and the user devices on the moving map in real time or near-real time. The mapping engine is operable to incorporate new user devices into the moving map in real time or near-real time without repeating the spatial survey using data from the location engine. For example, the spatial survey is conducted by an augmenting device when the system is set up for the first time, thereby creating the moving map. The moving map is then updated when the system detects new user devices (e.g., customer user devices) entering and/or leaving the area. In one embodiment, the system is operable to use machine learning techniques to create and/or update the moving map. In one embodiment, the mapping engine is operable to develop probability models for updating the moving map and direct the system to take action. In one embodiment, the mapping engine updates the moving map at a regular interval. In another embodiment, the mapping engine updates the moving map based on changes in any of the location data. The moving map is operable to be viewed on a user device. In one embodiment, the moving map is operable to be updated and viewed on a user device while the user device is in motion.

The location engine, the mapping engine, and the data collection engine are operable to share data with the radiofrequency devices. In one embodiment, the radiofrequency devices and user devices are further operable to share data with each other. The data includes but is not limited to user data, user device data, location engine data, mapping engine data, datum correction, data collection data, beacon data, tag data, and/or host data. The beacon data includes but is not limited to a location of the at least one beacon, signal protocols, signal data, a power status, software data, and/or hardware data. In one embodiment, the radiofrequency devices are operable to share data with each other at regular intervals. For example, the radiofrequency devices implement automatic dependent surveillance-broadcast (ADSB) protocols. Alternatively, the radiofrequency devices are operable to query each other for data. In one embodiment, the data is encoded. In one embodiment, the radiofrequency devices send and receive data using standard payload protocols (e.g., IBEACON, ALTBEACON, and/or EDDYSTONE formats). In a preferred but non-limiting example, the augmenting device is operable to share location engine data and mapping engine data with the beacons, and the beacons are operable to share the data with the user device. The location engine data and mapping engine data from the beacons are then used to refine the location data of the user device, thereby increasing the precision of the system.

In one embodiment, the present invention includes a cloud-based network, and the radiofrequency devices are operable to communicate with the cloud-based network. For example, location engine data, mapping engine data, and data collection engine data are stored and regularly updated on the cloud-based network. The radiofrequency devices are operable to query and receive the data from the cloud-based network.

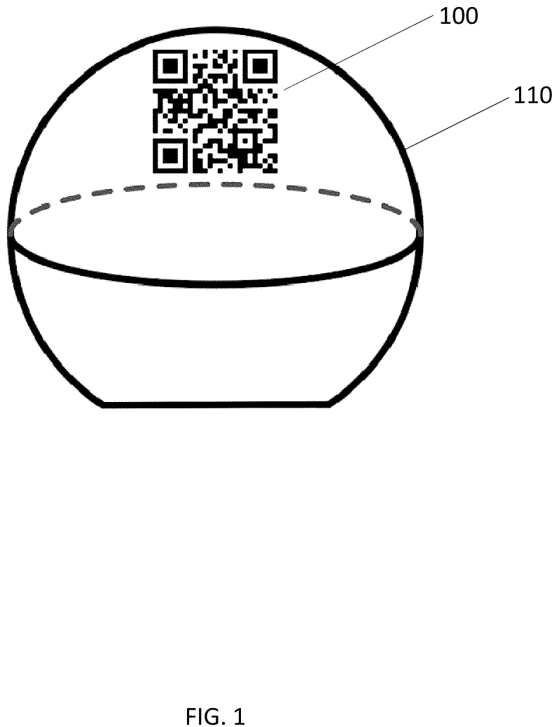

In one embodiment, the application of the present invention is initiated when the user device is used to scan a tag. The tag includes but is not limited to a Quick Response (QR) code, a barcode, a Universal Product Code (UPC), an image, an alphanumeric code, a Radiofrequency Identification (RFID) tag, a Near-Field Communication (NFC) tag, a table marker, and/or a smart card. In another embodiment, the tag is a hardware object. In one embodiment, the tag is attached to a radiofrequency device. For example, FIG. 1 illustrates an embodiment of the present invention wherein the tag is a QR code 100 attached to a beacon 110. Scanning the QR code 100 launches the application of the present invention. The beacon 110 in one embodiment includes hardware for location tracking. The tag is preferably located at an indoor location. For example, in one embodiment the tag is located on a table inside a restaurant. In another embodiment, the tag is affixed to a bar top. In yet another embodiment, the tag is affixed to a wall. In still another embodiment, the tag is affixed to a movable object, such as signage, promotional materials, coasters, menus, window dressings, drinking glasses, plates, silverware, and/or other objects. In one embodiment, the application of the present invention is automatically initiated when the user device enters into an area defined by a geofence. The geofence is operable to be created by radiofrequency devices (e.g., beacons).

In one embodiment, the data collection engine is operable to collect user device data through the application once the tag is scanned. The user device data includes but is not limited to hardware information, software information including a software version, location information, settings, permissions, sensor data, an IP address, a unique identifier, and/or information about applications available on the user device. In one embodiment, scanning the tag launches the application without further action from the user. In another embodiment, scanning the tag launches a modified version of the application wherein the modified version of the application has limited features. In yet another embodiment, the application is operable to be launched after receipt of a text message, web link, map card, activation code, and/or a suggestion from an artificial intelligence module associated with the user device. In one embodiment, the modified version of the application is an instant application, wherein the instant application is operable to be used without being fully downloaded onto the user device. In one embodiment, the modified version of the application has a size limit. A non-limiting example of the size limit is between about 4 Megabytes (MB) and about 10 MB. In another embodiment, the modified version of the application has restricted and/or reduced access to the hardware of the user device. In yet another embodiment, scanning the tag redirects the user device to enable the application and/or download the application. In one embodiment, when the modified version of the application is used frequently on the user device, the full application will eventually download onto the user device, without the user needing to download the application through an application store.

In one embodiment, the tag is associated with a host or owner. As a non-limiting example, the host is a restaurant and the tag is located at a table in the restaurant, wherein the tag and the table are associated with each other and are known to the restaurant. In one embodiment, each tag is associated with a unique ID, an encoding version, and a context ID. The unique ID is different for each individual tag and is able to be used by the system to distinguish between two tags that exist at approximately the same location. The context ID is unique to a particular object, person, or location, including but not limited to a menu, a table, a chair, a bartop, a sign, a parking space, promotional materials, a coaster, a waitlist, an employee, and/or structural elements (e.g., frontage, doors, and/or boundaries). By associating each tag with a context ID, the system is able to associate tags with their immediate environment and better ensure that the system is able to accurately map the location of the tags. In one embodiment, the present invention includes a host interface connected to the server, wherein the host interface includes tag data and host data. The host interface is operable to be updated by the host. The tag data includes but is not limited to the location of the tag, hardware information, and software information. In one embodiment, the user device receives the tag data and the host data upon scanning the tag. The host data includes but is not limited to a menu, an inventory, recommendations, pricing information, advertisements, discounts, availability information, an occupancy, a wait time, reservation information, and/or contact information.

In one embodiment, the data collection engine is operable to collect user data through the application after the user device scans the tag. The user data includes but is not limited to a user profile, user preferences, user selections, user membership information, a user tier, user contact information, user payment information, and/or location data. The present invention is operable to associate the user data and the user device data with the tag that is scanned by the user device. The present invention is also operable to update the user data and/or the user device data based on further interactions with the user device. In one embodiment, the application of the present invention asks for permission before collecting the user data and/or the user device data. As a non-limiting example, the data collection engine is operable to collect a food order from the user via the application on the user device.

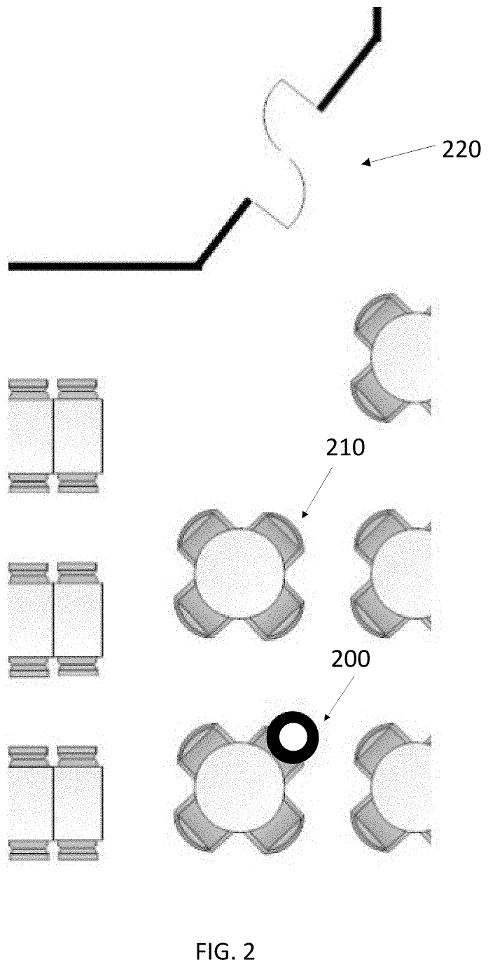

In a preferred embodiment, the mapping engine is operable to further combine the moving map with the data collected by the data collection engine. In one embodiment, the user data is combined with the moving map in a visualization on a user device. In one embodiment, the visualization includes a text and/or image overlay. FIG. 2 is an example of the visualization. The moving map includes a visual indicator 200 of the customer that is to be served next. The visualization also includes context for the surrounding areas including tables 210 and an entrance to the area 220. In one embodiment, the mapping engine is further operable to integrate the moving map and/or the visualization with sensor data from the user device. As a non-limiting example, the system is operable to overlay the moving map of the radiofrequency devices onto image data acquired by the user device. Alternatively, the system is operable to overlay the moving map onto video data acquired by the user device in real time or near-real time. In one embodiment, the visualization is an augmented reality (AR) visualization. In one embodiment, the system is operable to direct a user to a location based on the user data. In one embodiment, the user is a customer. In another embodiment, the user is a staff member.

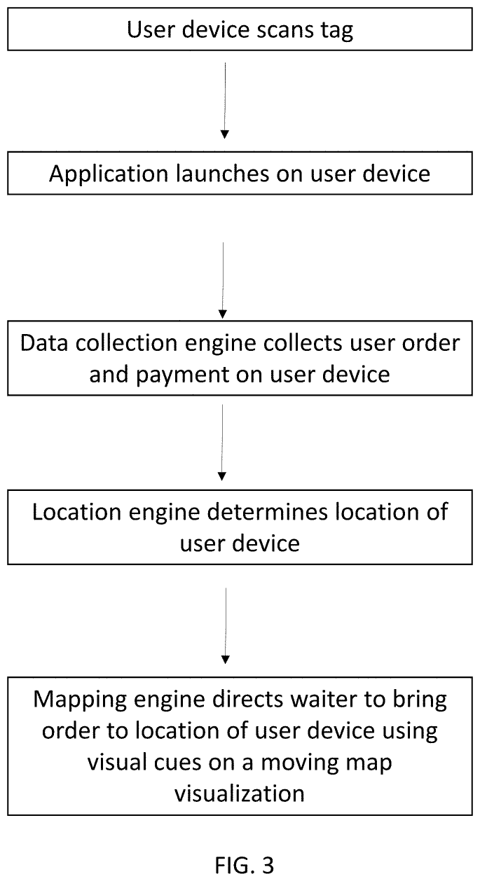

As a non-limiting example, a customer at a restaurant uses a customer user device (e.g., a smartphone) to scan the tag located at the table where they are seated. Scanning the tag initiates a menu and the customer places an order on the user device wherein the order is associated with the customer and the table where they are seated. The mapping engine creates a moving map of the restaurant, wherein the visualization of the moving map is displayed on a staff user device (e.g., a tablet). The visualization shows the order placed by the customer and the name of the customer along with the tag that was scanned by the customer at the table. The visualization directs a waiter to bring the order to the correct table. If the customer is not at the table, the location engine determines a current location of the user device of the customer and the mapping engine updates the moving map accordingly. For example, the customer is at a different table or in a standing area. The visualization then directs the waiter to bring the order directly to the customer. In one embodiment, the visualization highlights the location of the customer on a live video. In another embodiment, the visualization highlights a best route to the location of the customer on the live video. Alternatively, the staff user device provides text instructions to direct the waiter to the location of the customer. In yet another embodiment, the staff user device provides auditory cues to direct the waiter. FIG. 3 illustrates the process wherein the system takes the user's order and directs the waiter to deliver the order to the user. The application on the user device enables the user to decline to share the location of the user device. In one embodiment, the system enables the user to send a message from one user device to another user device. Alternatively, the system is operable to broadcast a message from one user device to a plurality of user devices. The system is also operable to make recommendations or send information to the user device based on the user data and/or the user device data.

In one embodiment, the AR visualization includes indications regarding the status of a table. The status of a table includes, by way of example and not of limitation, whether a customer is finished with their food, whether the customer requires a refill, whether the customer wants the check, whether the customer has a complaint, and/or any other identifying information regarding the customers at the table. The system is operable to generate status data using sensor data and computer vision techniques. For example, the system uses image data to determine how much food is on a plate or how much liquid is in a cup to determine whether a customer needs a refill. In one embodiment, while a user is using the AR visualization, the spatial survey of the areas viewed by the user is automatically conducted to update the moving map.

In one embodiment, the user device includes a pair of AR glasses. The AR glasses are operable to fully integrate with the application, with the visualization of the moving map appearing directly on the AR glasses. In one embodiment, the AR glasses include at least one camera, which is used to perform the spatial survey, while simultaneously displaying the text overlay to the user. In one embodiment, the AR glasses are operable to activate upon recognition of at least one QR code and/or at least one barcode.

In one embodiment, the application is able to automatically predict a service event, based on the visualization and sensor data. By way of example and not of limitation, the application is able to determine when a user stands up from their seats and leaves the table, when a user puts on a jacket or other external clothing, or when the user picks up a specialty menu and/or drink menu. In one embodiment, after the application predicts the service event, it sends a notification to a location manager, indicating the likelihood of the service event occurring. By predicting when, for example, a user is going to leave a location and informing the location manager of that possibility, the application assists location managers in better assessing potential wait times for tables and in more efficiently allocating new users to the table formerly occupied by the leaving user. Additionally, by predicting when, for example, a user is going to order an additional drink or specialty item, the system is able to alert servers to quickly go to the table so as to be able to take an order.

In one embodiment, the system includes a plurality of user tiers. The system collects and shares user data and/or user device data based on the user tier. User tiers are accessible via payment and/or membership. In a non-limiting example, the mapping engine only maps the locations of users who pay a membership fee. In one embodiment, the user device is operable to share and access data based on the user tier associated with the user device. In one embodiment, the user device is operable to access data stored on the server. For example, the customers who pay the membership fee have access to aggregated user data including reviews and/or ratings. In one embodiment, users associated with some or all of the plurality of user tiers are able to earn loyalty points based on the amount and frequency of use of the application. Loyalty points are able to be used, for example, to purchase in-application benefits, such as discounted memberships, and out-of-application benefits, such as discounts at select stores and restaurants. Additionally, in one embodiment, a user is able to earn loyalty points by recommending additional users to buy and/or use the application.

In one embodiment, the application includes user profiles for a plurality of users of the application. User profiles include a username, a password, a first name, a last name, an email address, a phone number, a list of other associated social media accounts, one or more challenge questions and/or challenge question answers, one or more associated payment accounts, a picture and/or avatar, a location history, a unique ID and/or a present location. User profiles also include a list of designated social contacts, representing one or more other user profiles of the application. In one embodiment, user profiles include privacy settings, indicating what information associated with the user profiles are able to be viewed by each of the designated social contacts and what information associated with the user profiles are able to be viewed by users of the application other than the list of the designated social contacts. In one embodiment, the moving map of each user includes indications of the location of other users. Including indications of the location of other users is especially useful in crowded environments, such as packed restaurants and bars, where finding specific individuals is difficult. The moving map is also operable to include locations of objects, such as a table that a user has reserved, or other areas such as the restroom. In one embodiment, the application includes a messaging feature, allowing users to communicate with one another. In one embodiment, the messaging feature includes an option to send a ping, which automatically sends an alert to a designated group of users to meet at a specific time (i.e., in 5 minutes, in 10 minutes, or now) and/or a specific place. The specific place included in the alert is able to be manually entered by a user or is automatically determined using the location data of the user sending the ping.

In one embodiment, the system is operable to detect and record how much time a user device spends at a given location. The system is also operable to detect and record interactions between users based on user device location. In another embodiment, the system is operable to categorize and/or analyze the user data and the user device data based on proximity of the user devices. For example, a group of people arrive at a location together, are seated together as one party, and scan the same tag. The system likewise groups the user data and the user device data from the party together for analysis and future action. The future action includes but is not limited to advertising, recommendations, and/or social media updates.

In one embodiment, all users seated at the same location are automatically added to a common tab after they each scan a tag at the location. In another embodiment, the location includes more than one tag, and users are able to scan different tags so as to be added to separate tabs. When a new user arrives at a location, they are able to scan the tag and instantly be added to the tab. In one embodiment, when a server takes an order for a user at a given location, the server is able to upload the order cost and a unique ID and/or context ID for the tag associated with the order such that the order is automatically added to the tab associated with the tag. In one embodiment, the tab associated with a particular user is automatically closed when the user device passes outside of a defined geofence. After the user leaves, the system is then able to notify the location manager, allowing the table or chair occupied by the user to be reassigned to a new user and allowing the location manager to send a payment request to the leaving user if their bill or tab is not entirely paid.

In one embodiment, the system is used for security purposes. The system is operable to detect when a user device is in a restricted area and send an alert to the user device and/or to the host. In another embodiment, the system is operable to detect when user devices are moving quickly towards or away from a certain location, thereby indicating a situation that requires urgent attention.

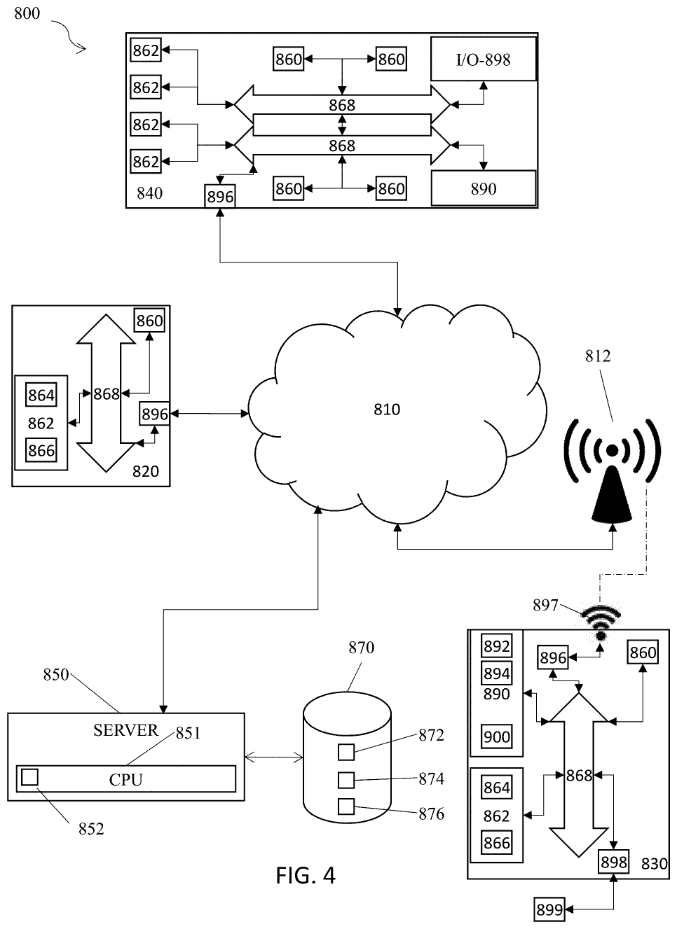

FIG. 4 is a schematic diagram of an embodiment of the invention illustrating a computer system, generally described as 800, having a network 810, a plurality of computing devices 820, 830, 840, a server 850, and a database 870.

The server 850 is constructed, configured, and coupled to enable communication over a network 810 with a plurality of computing devices 820, 830, 840. The server 850 includes a processing unit 851 with an operating system 852. The operating system 852 enables the server 850 to communicate through network 810 with the remote, distributed user devices. Database 870 is operable to house an operating system 872, memory 874, and programs 876.

In one embodiment of the invention, the system 800 includes a network 810 for distributed communication via a wireless communication antenna 812 and processing by at least one mobile communication computing device 830. Alternatively, wireless and wired communication and connectivity between devices and components described herein include wireless network communication such as WI-FI, WORLDWIDE INTEROPERABILITY FOR MICROWAVE ACCESS (WIMAX), Radio Frequency (RF) communication including RF identification (RFID), NEAR FIELD COMMUNICATION (NFC), BLUETOOTH including BLUETOOTH LOW ENERGY (BLE), ZIGBEE, Infrared (IR) communication, cellular communication, satellite communication, Universal Serial Bus (USB), Ethernet communications, communication via fiber-optic cables, coaxial cables, twisted pair cables, and/or any other type of wireless or wired communication. In another embodiment of the invention, the system 800 is a virtualized computing system capable of executing any or all aspects of software and/or application components presented herein on the computing devices 820, 830, 840. In certain aspects, the computer system 800 is operable to be implemented using hardware or a combination of software and hardware, either in a dedicated computing device, or integrated into another entity, or distributed across multiple entities or computing devices.

By way of example, and not limitation, the computing devices 820, 830, 840 are intended to represent various forms of electronic devices including at least a processor and a memory, such as a server, blade server, mainframe, mobile phone, personal digital assistant (PDA), smartphone, desktop computer, netbook computer, tablet computer, workstation, laptop, and other similar computing devices. The components shown here, their connections and relationships, and their functions, are meant to be exemplary only, and are not meant to limit implementations of the invention described and/or claimed in the present application.

In one embodiment, the computing device 820 includes components such as a processor 860, a system memory 862 having a random access memory (RAM) 864 and a read-only memory (ROM) 866, and a system bus 868 that couples the memory 862 to the processor 860. In another embodiment, the computing device 830 is operable to additionally include components such as a storage device 890 for storing the operating system 892 and one or more application programs 894, a network interface unit 896, and/or an input/output controller 898. Each of the components is operable to be coupled to each other through at least one bus 868. The input/output controller 898 is operable to receive and process input from, or provide output to, a number of other devices 899, including, but not limited to, alphanumeric input devices, mice, electronic styluses, display units, touch screens, signal generation devices (e.g., speakers), or printers.

By way of example, and not limitation, the processor 860 is operable to be a general-purpose microprocessor (e.g., a central processing unit (CPU)), a graphics processing unit (GPU), a microcontroller, a Digital Signal Processor (DSP), an Application Specific Integrated Circuit (ASIC), a Field Programmable Gate Array (FPGA), a Programmable Logic Device (PLD), a controller, a state machine, gated or transistor logic, discrete hardware components, or any other suitable entity or combinations thereof that can perform calculations, process instructions for execution, and/or other manipulations of information.

In another implementation, shown as 840 in FIG. 4, multiple processors 860 and/or multiple buses 868 are operable to be used, as appropriate, along with multiple memories 862 of multiple types (e.g., a combination of a DSP and a microprocessor, a plurality of microprocessors, one or more microprocessors in conjunction with a DSP core).

Also, multiple computing devices are operable to be connected, with each device providing portions of the necessary operations (e.g., a server bank, a group of blade servers, or a multi-processor system). Alternatively, some steps or methods are operable to be performed by circuitry that is specific to a given function.

According to various embodiments, the computer system 800 is operable to operate in a networked environment using logical connections to local and/or remote computing devices 820, 830, 840 through a network 810. A computing device 830 is operable to connect to a network 810 through a network interface unit 896 connected to a bus 868. Computing devices are operable to communicate communication media through wired networks, direct-wired connections or wirelessly, such as acoustic, RF, or infrared, through an antenna 897 in communication with the network antenna 812 and the network interface unit 896, which are operable to include digital signal processing circuitry when necessary. The network interface unit 896 is operable to provide for communications under various modes or protocols.

In one or more exemplary aspects, the instructions are operable to be implemented in hardware, software, firmware, or any combinations thereof. A computer readable medium is operable to provide volatile or non-volatile storage for one or more sets of instructions, such as operating systems, data structures, program modules, applications, or other data embodying any one or more of the methodologies or functions described herein. The computer readable medium is operable to include the memory 862, the processor 860, and/or the storage media 890 and is operable be a single medium or multiple media (e.g., a centralized or distributed computer system) that store the one or more sets of instructions 900. Non-transitory computer readable media includes all computer readable media, with the sole exception being a transitory, propagating signal per se. The instructions 900 are further operable to be transmitted or received over the network 810 via the network interface unit 896 as communication media, which is operable to include a modulated data signal such as a carrier wave or other transport mechanism and includes any delivery media. The term “modulated data signal” means a signal that has one or more of its characteristics changed or set in a manner as to encode information in the signal.

Storage devices 890 and memory 862 include, but are not limited to, volatile and non-volatile media such as cache, RAM, ROM, EPROM, EEPROM, FLASH memory, or other solid state memory technology; discs (e.g., digital versatile discs (DVD), HD-DVD, BLU-RAY, compact disc (CD), or CD-ROM) or other optical storage; magnetic cassettes, magnetic tape, magnetic disk storage, floppy disks, or other magnetic storage devices; or any other medium that can be used to store the computer readable instructions and which can be accessed by the computer system 800.

In one embodiment, the computer system 800 is within a cloud-based network. In one embodiment, the server 850 is a designated physical server for distributed computing devices 820, 830, and 840. In one embodiment, the server 850 is a cloud-based server platform. In one embodiment, the cloud-based server platform hosts serverless functions for distributed computing devices 820, 830, and 840.

In another embodiment, the computer system 800 is within an edge computing network. The server 850 is an edge server, and the database 870 is an edge database. The edge server 850 and the edge database 870 are part of an edge computing platform. In one embodiment, the edge server 850 and the edge database 870 are designated to distributed computing devices 820, 830, and 840. In one embodiment, the edge server 850 and the edge database 870 are not designated for distributed computing devices 820, 830, and 840. The distributed computing devices 820, 830, and 840 connect to an edge server in the edge computing network based on proximity, availability, latency, bandwidth, and/or other factors.

It is also contemplated that the computer system 800 is operable to not include all of the components shown in FIG. 4, is operable to include other components that are not explicitly shown in FIG. 4, or is operable to utilize an architecture completely different than that shown in FIG. 4. The various illustrative logical blocks, modules, elements, circuits, and algorithms described in connection with the embodiments disclosed herein are operable to be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application (e.g., arranged in a different order or partitioned in a different way), but such implementation decisions should not be interpreted as causing a departure from the scope of the present invention.

The above-mentioned examples are provided to serve the purpose of clarifying the aspects of the invention, and it will be apparent to one skilled in the art that they do not serve to limit the scope of the invention. By nature, this invention is highly adjustable, customizable and adaptable. The above-mentioned examples are just some of the many configurations that the mentioned components can take on. All modifications and improvements have been deleted herein for the sake of conciseness and readability but are properly within the scope of the present invention.

The invention claimed is:

1. A system for positioning and tracking at least one user device, comprising:
a server in network communication with at least one signaling device;
at least one sensor device in network communication with the server;
wherein the server is operable to receive scan data from the at least one sensor device, wherein the scan data includes a point cloud map of a location;
wherein the at least one signaling device is operable to receive signals from at least one user device and transmit messages to the server including signal data regarding the at least one user device; and
wherein the server is operable to determine a location of the at least one user device and/or at least one individual based on the scan data and the signal data.

2. The system of claim 1, wherein the at least one sensor device includes at least one LiDAR sensor and/or at least one camera.

3. The system of claim 1, wherein the server is operable to generate a map including the location of the at least one user device, and wherein the map is transmitted to at least one management device.

4. The system of claim 3, wherein the location of the at least one user device on the map is updated in real time or near-real time.

5. The system of claim 1, wherein the signal data includes received signal strength indication (RSSI) ranging data and/or trilateration data for the at least one user device.

6. The system of claim 1, wherein the server is operable to receive a location marker from the at least one signaling device, wherein the location marker indicates a current location of the at least one signaling device, and wherein the server is operable to transmit an alert to at least one management device when the at least one signaling device is outside of an expected location.

7. The system of claim 1, wherein the at least one user device includes at least one smart phone, at least one tablet, at least one wearable device, and/or at least one augmented reality (AR) device.

8. The system of claim 1, wherein the at least one signaling device includes at least one beacon, at least one radiofrequency tag, at least one wearable device, at least one tablet, at least one pay station, at least one router, and/or at least one smart phone.

9. The system of claim 1, wherein the server includes an artificial intelligence module operable to automatically identify features and/or objects in the point cloud map based on spatial hints and anchors.

10. A system for positioning and tracking at least one user, comprising:
a server in network communication with at least one signaling device;
at least one user device in network communication with the server and/or the at least one signaling device;
wherein the server is operable to receive scan data from the at least one user device, wherein the scan data corresponds to at least one unique identifier;
wherein the at least one signaling device is operable to receive signals from the at least one user device and transmit messages to the server including signal data regarding the at least one user device; and
wherein the server is operable to determine a location of the at least one user device based on the scan data and the signal data.

11. The system of claim 10, wherein the at least one unique identifier includes at least one Quick Response (QR) code, at least one barcode, at least one Universal Product Code (UPC), at least one Radiofrequency Identification (RFID) tag, and/or at least one Near-Field Communication (NFC) tag.

12. The system of claim 10, wherein the server is operable to generate a map including the location of the at least one user device, and wherein the map is transmitted to at least one management device.

13. The system of claim 12, wherein the location of the at least one user device on the map is updated in real time or near-real time.

14. The system of claim 12, wherein the map includes an augmented reality visualization including a text and/or image overlay indicating the location of each of the at least one user device.

15. The system of claim 10, wherein the at least one user device includes at least one smart phone, at least one tablet, at least one wearable device, and/or at least one augmented reality (AR) device.

16. The system of claim 10, wherein the at least one signaling device includes at least one beacon, at least one radiofrequency tag, at least one wearable device, at least one tablet, at least one pay station, at least one router, and/or at least one smart phone.

17. A method for positioning and tracking at least one user, comprising:
a server receiving scan data from at least one sensor device, wherein the scan data includes a point cloud map of a location in the vicinity of the at least one sensor device;
at least one signaling device receiving signals from at least one user device and transmitting messages to the server including signal data regarding the at least one user device;
the server determining a location of the at least one user device based on the scan data and the signal data; and
the server generating a map including the location of the at least one user device and/or at least one individual, and transmitting the map to at least one management device.

18. The method of claim 17, further comprising the server generating the map in real time or near-real time.

19. The method of claim 17, wherein the server includes an artificial intelligence module, further comprising the artificial intelligence module automatically identifying features and/or objects in the point cloud map based on spatial hints and anchors.

20. The method of claim 17, wherein the at least one sensor device includes at least one LiDAR sensor and/or at least one camera.
